(19) United States
(12) Patent Application Publication
(10) Pub. No.: US 2015/0073759 A1
(43) Pub. Date: Mar. 12, 2015

(54) PREDICTION ACCURACY IN A SPATIO-TEMPORAL PREDICTION SYSTEM

(71) Applicant: Public Engines, Inc., Draper, UT (US)

(72) Inventors: Praneeth Vepakomma, South Jordan, UT (US); Eric Copp, West Jordan, UT (US); Andrew Reynolds, Murray, UT (US)

(21) Appl. No.: 14/480,523

(22) Filed: Sep. 8, 2014

Related U.S. Application Data
(60) Provisional application No. 61/874,844, filed on Sep. 6, 2013.

(51) Int. Cl. G06F 17/30; G06Q 50/26

(52) U.S. Cl. CPC G06F 17/30705; G06Q 50/265
USPC 703/6

(57) ABSTRACT

An apparatus, method, and computer program product are disclosed for improving prediction accuracy in a spatio-temporal prediction system. A data module receives spatio-temporal data comprising a one or more of a time and location. An estimation module generates one or more prediction probabilities for the spatio-temporal data. A sampling module generates one or more resamples of the prediction probabilities.

### CROSS-REFERENCES TO RELATED APPLICATIONS

This application claims the benefit of U.S. Provisional Patent Application No. 61/874,844 entitled “IMPROVING PREDICTION ACCURACY IN A SPATIO-TEMPORAL PREDICTION SYSTEM” and filed on Sep. 6, 2013, for Praneeth Vepakomma, which is incorporated herein by reference.

### FIELD

This invention relates to predicting future events and more particularly relates to predicting future crime events based on historical crime data.

### BACKGROUND

Predicting future events based on historical data may help decision makers determine where to focus their time, resources, attention, etc. In certain industries, predicting future events may be more important than saving time or resources. For example, in the law enforcement industry, being able to predict where certain crimes are likely to occur may allow law enforcement agencies to focus their time and resources on specific areas to prevent crimes, and any ensuing dangers, from occurring. Existing event-prediction methods may not provide the automation, speed, or efficiency of computer-implemented prediction methods. Moreover, existing event-prediction methods may be too tedious or slow to provide prediction results on a consistent, scheduled basis, such as daily, weekly, etc.

### BRIEF SUMMARY

An apparatus for correcting inconsistencies in a spatio-temporal prediction system is disclosed. A method and computer program product also perform the functions of the apparatus. In one embodiment, an apparatus includes a data module configured to receive spatio-temporal data. In one embodiment, the spatio-temporal data comprises one or more of a time and a location. In certain embodiments, an estimation module is configured to generate one or more prediction probabilities for the spatio-temporal data. In a further embodiment, a sampling module is configured to generate one or more resamples of the prediction probabilities.

In one embodiment, the one or more prediction probabilities are calculated based on estimated values derived from the spatio-temporal data. In certain embodiments, the estimation module further provides the spatio-temporal data to a point-processing model to generate the estimated values. The point-processing model may be based on a Hawkes point-processing model. In one embodiment, the estimation module further divides the time value of the spatio-temporal data into a plurality of time variables representing a subset of the time value. The plurality of time variables may be used as input into the point-processing model.

In some embodiments, the estimation module further estimates a three-dimensional kernel density of a predetermined mesh size for the spatio-temporal data as part of the point-processing model. In certain embodiments, the estimated three-dimensional kernel density is calculated using a Gaussian transformation of the spatio-temporal data. In a further embodiment, the estimation module further down-samples the spatio-temporal data by selecting a subset of the spatio-temporal data. In a further embodiment, the estimation module generates the prediction probabilities according to a predetermined schedule.

In some embodiments, the sampling module performs an ensemble learning method to generate one or more resamples of the prediction probabilities. In one embodiment, a correction module is configured to generate one or more rankings associated with the one or more prediction probabilities while correcting one or more inconsistencies of the one or more prediction probabilities. In certain embodiments, the sampling module generates one or more resamples of the prediction probabilities according to the one or more rankings associated with the one or more prediction probabilities.

In a further embodiment, the spatio-temporal data comprises crime-related data that comprises a location of a crime and a date of a crime. In certain embodiments, the prediction probabilities describe the likelihood of a future crime occurring. In one embodiment, a map module is configured to display an area of a map associated with the spatio-temporal crime-related data. In a further embodiment, an overlay module is configured to overlay one or more hotspots on a map. In some embodiments, the one or more hotspots indicate an area on the map that has a prediction probability above a predetermined threshold. In certain embodiments, the one or more hotspots are associated with one or more selected crimes and represent a likelihood of a near-repeat of a selected crime occurring in an area of the map associated with the hotspot.

A method is included that receives spatio-temporal data comprising one or more of a time and a location. In a further embodiment, the method includes generating one or more prediction probabilities for the spatio-temporal data. In some embodiments, the method includes generating one or more resamples of the prediction probabilities. The method, in certain embodiments, includes generating one or more rankings associated with the one or more prediction probabilities while correcting one or more inconsistencies of the one or more prediction probabilities. In some embodiments, the one or more resamples of the prediction probabilities are generated according to the one or more rankings associated with the one or more prediction probabilities.

In a further embodiment, the method includes displaying an area of a map associated with the spatio-temporal data. In some embodiments, the spatio-temporal data includes crime-related data comprising a location of a crime and a date of a crime. In certain embodiments, the prediction probabilities describe the likelihood of a future crime occurring. In some embodiments, the method includes overlaying one or more hotspots on a map. In one embodiment, the one or more hotspots indicate an area on the map that has a prediction probability above a predetermined threshold. In a further embodiment, the one or more hotspots are associated with one or more selected crimes and represent a likelihood of a near-repeat of a selected crime occurring in an area of the map associated with the hotspot.

In one embodiment, a program product is disclosed that includes a computer readable storage medium that stores code executable by a processor. In one embodiment, the executable code comprises code to perform receiving spatio-temporal data comprising one or more of a time and a location. In certain embodiments, the executable code comprises code to perform generating one or more prediction probabilities for the spatio-temporal data. In one embodiment, the one or more prediction probabilities are calculated based on estimated values derived from the spatio-temporal data. In a further embodiment, the executable code comprises code to perform generating one or more resamples of the prediction probabilities according to one or more rankings associated with the one or more prediction probabilities.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention, and are not therefore to be considered to be limiting of its scope, the invention will be described and explained with additional specificity and detail through the use of the accompanying drawings, in which:

FIG. 1 is a schematic block diagram illustrating one embodiment of a system for improving accuracy in a spatio-temporal prediction system;

FIG. 2 is a schematic block diagram illustrating one embodiment of a spatio-temporal prediction system;

FIG. 3A is a schematic block diagram illustrating one embodiment of an apparatus for improving accuracy in a spatio-temporal prediction system;

FIG. 3B is a schematic block diagram illustrating one embodiment of another apparatus for improving accuracy in a spatio-temporal prediction system;

FIG. 4 is a schematic flow chart diagram illustrating one embodiment of a method for improving accuracy in a spatio-temporal prediction system;

FIG. 5 is a schematic flow chart diagram illustrating one embodiment of another method for improving accuracy in a spatio-temporal prediction system;

FIG. 6 is a schematic flow chart diagram illustrating yet another embodiment of a method for improving accuracy in a spatio-temporal prediction system; and

FIG. 7 illustrates one embodiment of crime-prediction map.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

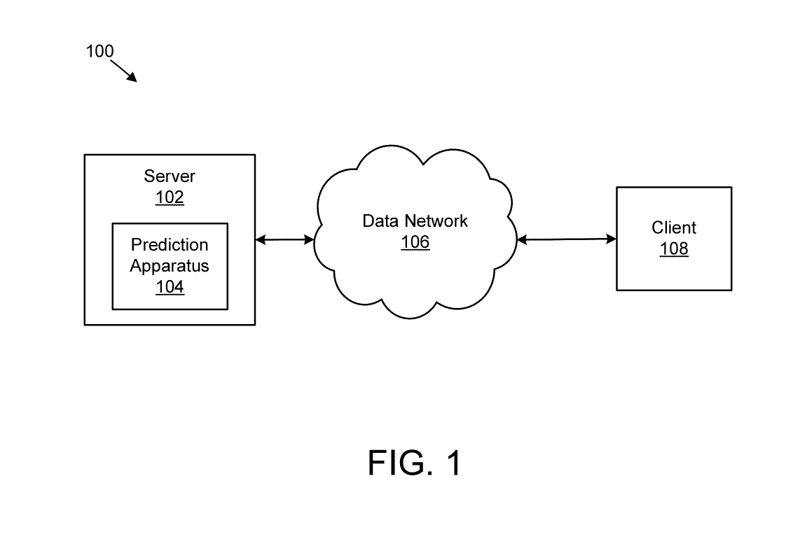

FIG. 1 depicts one embodiment of a system 100 for improving accuracy in a spatio-temporal prediction system. The system 100, in one embodiment, includes a server 102, an ordering apparatus 104, a data network 106, and a client 108, which are described in more detail below.

In one embodiment, the system 100 includes a server 102. The server 102, in some embodiments, includes a main frame computer, a desktop computer, a laptop computer, a cloud server, and/or the like. In certain embodiments, the server 102 includes at least a portion of the ordering apparatus 104. In another embodiment, the client 108 is communicatively coupled to the server 102 through the data network 106. The client 108, in some embodiments, obtains at least a portion of its data from the server 102. The server, in certain embodiments, includes a storage device, such as a database, configured to store data associated with an event-prediction system. In one embodiment, the storage device stores crime-related data, which may include a crime, a timestamp, a location (e.g., an address, longitude/latitude coordinates, or the like), and/or the like.

In another embodiment, the system 100 includes a prediction apparatus 104. As described below in more detail, in one embodiment, the prediction apparatus 104 receives spatio-temporal data. In some embodiments, the spatio-temporal data includes raw data comprising a crime type, a location, a time stamp, and/or the like. In another embodiment, the prediction apparatus 104 generates a real matrix of one or more prediction probabilities based on estimates derived from the spatio-temporal data. As used herein, the prediction probabilities describe the likelihood of an event occurring in the future, such as a specific crime, or near-repeat crime, which is a predicted probability of a future crime based on prediction probabilities of similar crimes. In one embodiment, the prediction apparatus 104 generates one or more rankings associated with the prediction probabilities while correcting one or more inconsistencies in the real matrix of probabilities. In certain embodiments, the prediction apparatus 104 generates one or more resamples of the prediction probabilities based on the real matrix of prediction probabilities and the one or more rankings.

In certain embodiments, the system 100 includes a data network 106. The data network 106, in certain embodiments, is a digital communication network 106 that transmits digital communications related to improving accuracy in a spatio-temporal prediction system. The digital communication network 106 may include a wireless network, such as a wireless telephone network, a local wireless network, such as a Wi-Fi network, a Bluetooth® network, and the like. The digital communication network 106 may include a wide area network (“WAN”), a storage area network (“SAN”), a local area network (“LAN”), an optical fiber network, the internet, or other digital communication network known in the art. The digital communication network 106 may include two or more networks. The digital communication network 106 may include one or more servers, routers, switches, and/or other networking equipment. The digital communication network 106 may also include computer readable storage media, such as a hard disk drive, an optical drive, non-volatile memory, random access memory (“RAM”), or the like.

In another embodiment, the system 100 includes a client 108. In one embodiment, the client 108 includes a desktop computer, a laptop computer, a mobile device, a smart phone, a tablet computer, a smart TV, and/or the like. In certain embodiments, the client 108 includes an electronic display configured to present a prediction interface to a user. In some embodiments, the prediction interface includes a map and a crime-prediction overlay such that the user visually sees one or more predicted crime events within a geographic region.

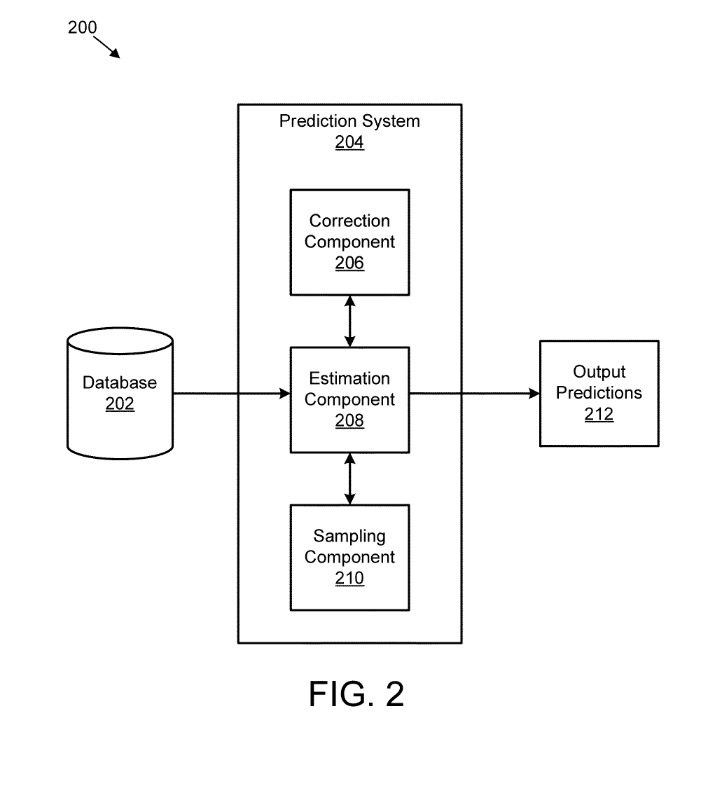

FIG. 2 depicts one embodiment of a spatio-temporal prediction system 200. In certain embodiments, the system 200 includes a database 202, a prediction system 204 and one or more output predictions 212. In certain embodiments, the prediction system 204 includes a correction component 206, an estimation component 208, and a sampling component 210. In certain embodiments, the database 202 and the prediction system 204 are located on the server 102 and include at least a portion of the ordering apparatus 104.

In one embodiment, the database 202 includes raw spatio-temporal data. In certain embodiments, the raw spatio-temporal data includes crime-event data, such as the type of crime, the location of the crime (e.g., an address, a longitude/latitude pair, or the like), the time of the crime, and/or the like. The raw spatio-temporal data, in one embodiment, is processed by the prediction system 204 to produce one or more output predictions 212, such as near-repeat crime predictions based on raw crime-event data. Near-repeat crime predictions, as used herein, describe the likelihood of a crime occurring based on similar reported crime incidents within a specified area and/or time. The raw crime-event data, in certain embodiments, is manually entered by law enforcement personnel, which may make it difficult to rank the data. For example, crime related data may be ranked in terms of priority, best-to-worst, or the like. By manually ranking crime-event data, due to its subjective nature, one or more ordering inconsistencies in the data may be generated. Thus, the correction component 206 of the prediction system 204, in certain embodiments, corrects for these inconsistencies such that more accurate rankings of crime data are available for law enforcement personnel.

In certain embodiments, the database 202 provides raw spatio-temporal data to the estimation component 208. The estimation component 208, in certain embodiments, processes the raw spatio-temporal data and converts the raw spatio-temporal data into one or more event-prediction probabilities. In some embodiments, the estimation component 208 iteratively estimates a probability matrix with probabilities of repeat events in the spatial proximity and with a temporal shift of the down-sampled input spatio-temporal data. In certain embodiments, the matrix comprises an asymmetric matrix, a symmetric matrix, a skew symmetric matrix, and/or any matrix containing real numbers.

In certain embodiments, the estimation component 208 sends event-prediction probabilities to a sampling component 210 for further processing. The sampling component 210, in one embodiment, produces resamples, as well as necessary up- and down-samples, based on iterative rankings and asymmetric probability estimates. As used herein, sampling refers to selecting a subset of the spatio-temporal data in order to estimate one or more characteristics of the entire spatio-temporal data set. Similarly, resampling refers to selecting subsets of the spatio-temporal data set with replacement, which may also be referred to as bootstrapping. After processing the event-prediction probabilities, the sampling component 210 sends the processed data to the estimation component 208.

The estimation component 208, in another embodiment, sends the matrix of event-prediction probabilities to the correction component 206, which iteratively removes intransitivity and inconsistency relations from asymmetric matrices of probabilities generated by the estimation 208 and the sampling 210 components. In certain embodiments, the correction component 206 removes the inconsistencies at each iteration and produces global rankings of spatio-temporal data. For example, one set of data points a, b, c may be ranked a<b<c, where a has a higher rank than c, by one user while the same, or similar, set of data points a, b, c may be ranked b<c<a, where b has a higher rank than a, by a different user. The correction component 206, in certain embodiments, generates an overall ranking of the values within the data sets while adjusting for the inconsistencies in the rankings. The operations of the correction component 206 are discussed in more detail below.

The correction component 206, in another embodiment, sends the generated rankings of the event-prediction probabilities back to the estimation component 208, which incorporates the rankings into the current event-prediction data and begins a new iteration. The estimation component 208, in certain embodiments, outputs 212 the event-prediction matrix. The event-prediction matrix may be outputted in response to the number of iterations reaching a threshold value, a metric being reached, one or more values converging to a predetermined value, and/or the like. The output prediction matrix, in certain embodiments, is a square matrix, which has the same number of rows and columns, where the diagonal values contain the event-prediction probabilities that are of interest. In some embodiments, the event-prediction matrix contains predictive crime-related probabilities and the diagonal of the matrix describes the predictive probabilities of a specific crime being committed at a specific location and time. In some embodiments, lower probabilities (e.g., closer to zero) indicates a higher likelihood of a near-repeat.

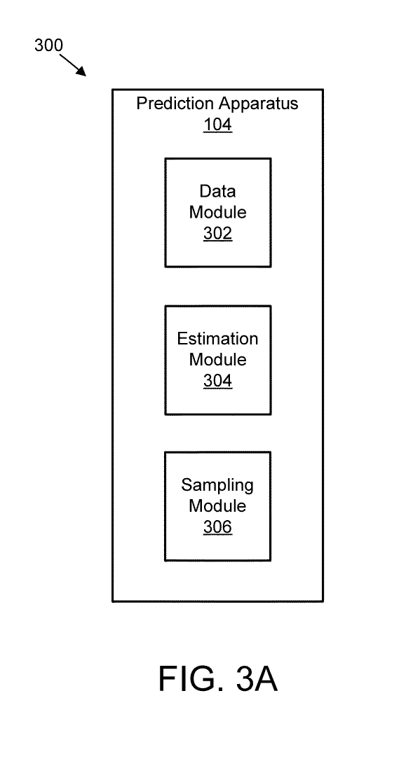

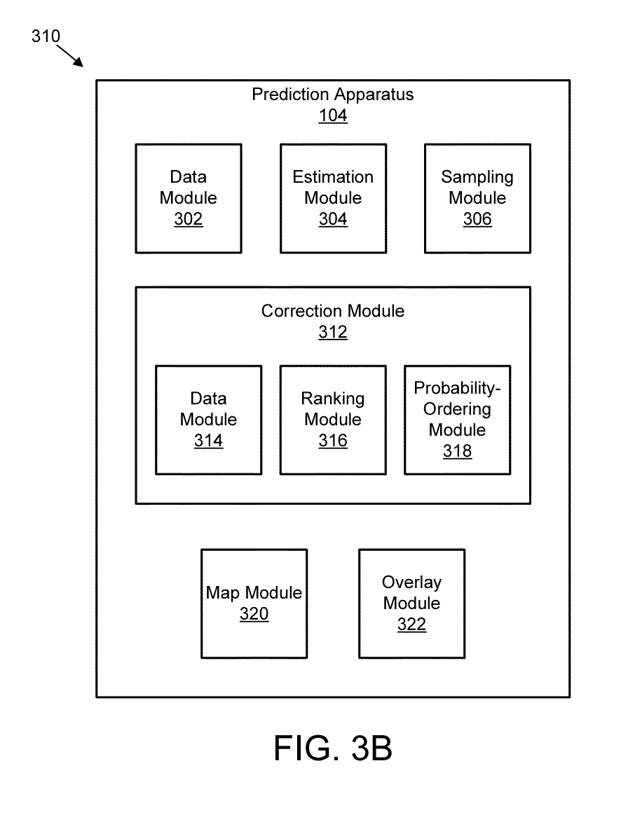

FIG. 3A depicts one embodiment of an apparatus 300 for improving accuracy in a spatio-temporal prediction system. In one embodiment, the apparatus 300 includes a prediction apparatus 104. The prediction apparatus 104, in certain embodiments, includes a data module 302, an estimation module 304, and a sampling module 306, which are described in more detail below. In certain embodiments, at least a portion of the prediction apparatus 104 is located on the estimation component 208 and the sampling component 210 of the prediction system 204, and performs at least a portion of the operations associated with the estimation component 208 and the sampling component 210.

In one embodiment, the prediction apparatus 104 includes a data module 302 configured to receive raw spatio-temporal data. In another embodiment, the raw spatio-temporal data includes crime data comprising a crime type, a crime location (e.g, an address, a latitude/longitude pair, or the like), a crime timestamp, and/or the like. In certain embodiments, the raw spatio-temporal data is stored on the server 102 (e.g., in a datastore such as a database 202). Officers and law enforcement personnel, in some embodiments, manually enter the spatio-temporal data. In some embodiments, the data is entered on a client 108 device, and is received by the server 102 through the data network 106. Because the data may be manually entered, inconsistencies within the data may be created. For example, different law enforcement personnel may rank or order a plurality of crimes differently, in terms of priority, likelihood of being repeated, risk level, or the like, which may introduce inconsistencies into the spatio-temporal data. In certain embodiments, as part of the prediction system 204, the correction component 206 corrects for these inconsistencies, which improves the accuracy of the output predictions 212 of the prediction system 204.

In one embodiment, the prediction apparatus 104 includes an estimation module 304 configured to generate a real matrix comprising one or more prediction probabilities. In certain embodiments, the prediction probabilities are calculated based on estimated values derived from the spatio-temporal data. In some embodiments, the estimation module 304 iteratively estimates one or more prediction probabilities by incorporating outputs generated by the correction component 206 and the sampling component 210. In one embodiment, the estimation module 302 determines a fixed mesh size associated with the received spatio-temporal data. In certain embodiments, the mesh size is an integer value that fixes the sample size of the two-dimensional and/or three-dimensional kernel density estimates. In some embodiments, the estimation module 302 selects the mesh size by cross-validation, which, as used herein, is a model validation technique for assessing how the results of a statistical analysis will generalize to an independent data set.

In another embodiment, the estimation module 304 uses a modified point-processing model to estimate the one or more prediction probabilities in the real matrix. In certain embodiments, the point-processing model is based on the Hawkes point-processing model. As used herein, a point-processing model may refer to a type of random process for which any one realization consists of a set of isolated points either in time or geographical space, such as the raw spatio-temporal crime data that includes a time stamp and a geographic location.

The estimation module 304, in another embodiment, sends a plurality of input data variables to the point-processing model to be processed in order to generate one or more prediction probability estimates. In one embodiment, the point-processing model receives one or more spatial variables and one or more time variables from the estimation module 304 in order to determine the interactions between the spatial data and the time data. The spatial and time variables, in some embodiments, represents the raw spatio-temporal crime data. In one embodiment, the estimation module 304 splits the timestamp value into a plurality of time variables representing a subset of the timestamp value. For example, the timestamp variable may include a date (e.g., day, month, year) and a time (e.g., hours, minutes, seconds) combined into a single variable. The estimation module 304 may split the timestamp into a plurality of variables such as a day variable, a month variable, a year variable, an hour variable, a minute variable, a seconds variable, and/or the like. In another embodiment, the estimation module 304 creates one or more accumulator variables, such as a variable representing the accumulated amount of time that has occurred from the earliest data point (e.g., crime incident) to the most recent data point.

The estimation module 304, in one embodiment, sends the spatial variables (e.g., a latitude variable and a longitude variable), the plurality of timing variables, and the accumulated time variable to the modified point-processing model. In certain embodiments, splitting the timestamp variable into a plurality of time variables provides greater accuracy because the point-processing model is able to generate more interactions between the spatial data and the various timing variables. For example, crime incidents may be seasonal, e.g., there may be more crime incidents at night than during the day, or there may be more crime incidents during the weekend than during weekdays. Thus, by splitting the time stamp variable into multiple time variables, the estimation module 304 is able to generate more accurate and refined prediction probabilities based on the spatial data.

In order to solve the modified point-processing model, in another embodiment, the estimation module 304 estimates a three-dimensional kernel density on the input variables (e.g., the spatial and time variables) of a given mesh size. In certain embodiments, the kernel density estimation is performed using a fast Gaussian transformation on the input data. In one embodiment, the estimation module 304 performs the kernel density estimation on a combination of the time variables, a combination of the spatial variables, and a combination of the time variables and the spatial variables.

In some embodiments, the estimation module 304 down-samples the raw spatio-temporal data by selecting a subset of the larger data set for processing. For example, the estimation module 304 may only select 500 spatio-temporal data points to process from a data set comprising 1,000 spatio-temporal data points. In this manner, the prediction system 204 is able to run computationally-intensive processes (e.g., high-dimensional kernel density estimation calculations) associated with the point-process model in a tractable manner (e.g., according to a predetermined schedule, such as daily, weekly, etc.). For example, the prediction system 204 may generate output predictions nightly such that law enforcement personnel may have updated predictions for the following work day. The prediction probabilities generated from the sub-sample, in certain embodiments, are then re-mapped to the original data set, such that the prediction overlay on the map is associated with the entire data set of spatio-temporal data. The efficiency of the prediction system 204 is discussed more below with reference to the sampling module 306.

In a further embodiment, the estimation module 304 fixes a sub-sample size and a bootstrap resample size. In a further embodiment, the estimation module 304 fixes a future timestamp used in the calculation of the prediction probabilities. At this point, the estimation module 304 may begin iteratively estimating prediction probabilities. The estimation module 304 may begin one or more iterations by generating a vector of resampling probabilities. In some embodiments, the sampling module 306, described in more detail below, generates the vector of resampling prediction probabilities. In another embodiment, during each iteration, the sampling module 306 resamples the estimated prediction probabilities after a correction module 312, also described in more detail below, corrects the ordering of the estimated prediction probabilities and generates one or more global rankings. In certain embodiments, the sampling module 306 resamples the estimated prediction probabilities based on the global rankings generated by the correction module 312.

In certain embodiments, the estimation module 304 computes spatial and/or temporal three-dimensional kernel density estimates of the selected sub-sample or prediction probabilities. In one embodiment, the estimation module 304 calculates a sum A of the three-dimensional kernel density estimates of the spatio-temporal data, which has been translated along the time dimension by the predefined future timestamp. In a further embodiment, the estimation module 304 calculates a multiple B of the dimensions of the spatial kernel density estimates indexed by a specific spatial location of interest for prediction.

The estimation module 304, in certain embodiments, calculates C=A+B by taking the result of the sums of the three-dimensional kernel density estimates of the spatio-temporal data, A, and adding A to the result, B, of the multiple of the dimensions of the spatial kernel density estimates indexed by a specific spatial location of interest for prediction to calculate C. The estimation module 304, in another embodiment, calculates

$$\frac{A}{C}$$

and stores the result in m, which is a real matrix of prediction probabilities. In a further embodiment, the estimation module 304 calculates

$$\frac{B}{C}$$

and stores the result in a memory-indexed data object, such as a vector, an array, a linked list, or the like. The estimation module 304, in one embodiment, iteratively calculates A, B, and C until matrix M has been populated.

In one embodiment, the prediction apparatus 104 includes a sampling module 306 configured to generate one or more resamples of the prediction probabilities based on the real matrix M of prediction probabilities and one or more global rankings as calculated by the correction module 312 described below. In certain embodiments, the sampling module 306 is a part of the sampling component 210 and performs one or more operations of the sampling component. For each iteration, the sampling module 306, in one embodiment, receives a real matrix M of prediction probabilities and one or more rankings associated with the prediction probabilities as calculated by the correction module 312, described below. In certain embodiments, the sampling module 306 generates a new sub-sample based on the received prediction probabilities and the rankings. The sub-sample, in one embodiment, is processed by the estimation component 208 and the correction component 206 in a new iteration.

In certain embodiments, by iteratively processing selected sub-samples, the sampling module 306 allows the prediction system 204 to efficiently process computationally-intensive operations in a tractable manner. For example, spatio-temporal crime data may be processed to create crime-prediction data in a way that crime-prediction data is available daily for law enforcement personnel to use.

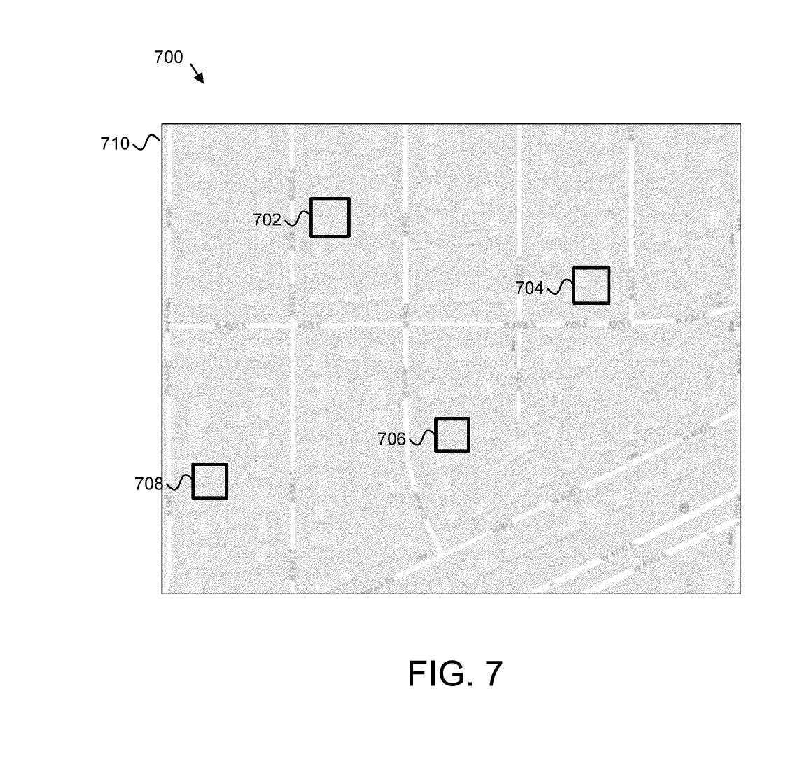

In one embodiment, sampling module 306 updates ensemble-learnt weights calculated using the received global rankings as generated by the correction module 312. As used herein, ensemble learning refers to the use of multiple learning algorithms to obtain better predictive performance than could be obtained from any of the constituent learning algorithms. Different ensemble learning methods may include statistical ensembles, machine learning ensembles, or the like. In certain embodiments, the sampling module 306 utilizes an ensemble algorithm, such as rankBoost, to combine the preferences received from global rankings as generated by the correction module 312 along with another set of rankings generated by a collection of other local and global ranking techniques. The sampling module 306, in a further embodiment, updates the bootstrap resampling probabilities based on the ensemble-learnt weights. In another embodiment, the sampling module 306 outputs the resampling probabilities, which may be used in a new iteration by the estimation module 304 and the correction module 312. In another embodiment, the sampling module 306 outputs the final predictions, which become the center points of the prediction boxes displayed in the map overlay, as depicted in FIG. 7.

FIG. 3B depicts another embodiment of an apparatus 310 for improving prediction accuracy in a spatio-temporal prediction system. In one embodiment, the apparatus 310 includes an prediction apparatus 104. The prediction apparatus 104, in certain embodiments, includes a data module 302, an estimation module 304, and a sampling module 306, which are substantially similar to the data module 302, estimation module 304, and sampling module 306 described with reference to FIG. 3A. In a further embodiment, the prediction apparatus includes a correction module 312, which includes a data module 314, a ranking module 316, a probability-ordering module 318, a map module 320 and an overlay module 322, which are described below.

In certain embodiments, the modules 314-318 perform the operations of the correction component 206, which includes formulating discrete Helmholtz-Hodge decomposition (also known as discrete Hodge-Helmholtz decomposition or discrete Helmholtz decomposition) on the estimates of the probabilities obtained from a bootstrapped point process model. In certain embodiments, the probabilities are for a class of symmetric matrices. In a further embodiment, the correction component 206 performs discrete Helmholtz-Hodge decomposition on asymmetric class of probabilistic matrices by producing an equivalent class of matrices.

In one embodiment, the prediction apparatus 104 includes a data module 314 configured to receive event-prediction data. In some embodiments, the event-prediction data includes a real matrix of prediction probabilities, where each value in the matrix has a value between zero and one, inclusive. In some embodiments, the real matrix of prediction probabilities includes one or more ordering inconsistencies. In certain embodiments, the real matrix is an asymmetric matrix P created by an iteration of processing by the estimation component 208 and the sampling component 210. In a further embodiment, the real matrix includes a symmetric matrix, a skew-symmetric matrix, or any matrix containing real numbers.

In another embodiment, the prediction apparatus 104 includes a ranking module 316 configured to calculate one or more event-prediction rankings based on the event-prediction probability data while adjusting for the one or more ordering inconsistencies. In one embodiment, in order to generate the one or more event-prediction rankings, the ranking module 316 performs one or more mathematical operations on the matrix P received by the data module 314, as described below.

In one embodiment, the ranking module 316 receives the matrix P received by the data module 314. The matrix P, in another embodiment, is an asymmetric matrix populated with a plurality of real numbers. In a further embodiment, the matrix P is a symmetric matrix, skew symmetric matrix, and/or the like.

In one embodiment where the matrix P is any real matrix, such as an asymmetric real matrix, the ranking module 316 represents P as the sum of a symmetric matrix A and a skew-symmetric matrix B, respectively: P=A+B where

$$A = \frac{P + {P}^{T}}{2} and B = \frac{P - {P}^{T}}{2} .$$

In certain embodiments, the ranking module 316 processes any real matrix P, and is not limited solely to symmetric or skew-symmetric matrices as inputs, as in traditional ranking and ordering algorithms.

In a further embodiment, the ranking module 316, for each dimension d={2, 3, . . . k}, where k is a predetermined threshold value, nonlinearly embeds the off-diagonal part of the symmetric matrix A, which contains the ordering inconsistencies, into dimensions d={2, 3, . . . k} considering it to be a similarity matrix that produces a set of matrices e={E₂, E₃, . . . Eₖ}.

The ranking module 316, in another embodiment, computes one or more distance matrices d={DP₂, DP₃, . . . DPₖ}, where each distance matrix DP contains the distances, taken pairwise, between a set of points. In one embodiment, distance matrix DPₙ is formed such that the upper-diagonal is the upper-diagonal of P and the lower-diagonal is the transpose of the upper-diagonal of P. In certain embodiments, the ranking module 316 calculates the distance matrices DP based on the matrices within the set e={E₂, E₃, . . . Eₖ}, such as calculating the distances between the embed matrices e={E₂, E₃, . . . Eₖ}.

In a further embodiment, the ranking module 316 calculates k weight matrices Wᵢⱼ^{k}=Σ[log(DPᵢⱼ^{k})−log(DPⱼᵢ^{k})], where DP is the embedded distance matrix for each dimension d={2, 3, . . . k}. The ranking module 316, in another embodiment, computes the discrete Helmholtz-Hodge decomposition of each weight matrix W. In one embodiment, the ranking module 316 computes the discrete Helmholtz-Hodge decomposition of skew-symmetric matrix B. The output of the discrete Helmholtz-Hodge decomposition of each weight matrix W and the skew-symmetric matrix B comprises 1 to k−1 orderings/rankings. In certain embodiments, the orderings comprise a plurality of column vectors (1 . . . k−1 vectors), where each column vector comprises orderings or rearranged indices. In a further embodiment, the ranking module 316 calculates the average of all the orderings produced by using symmetric matrix A and skew-symmetric matrix B to generate R1, which is a ranking of the calculated averages of all the ordering vectors.

In another embodiment, the ranking module 316 produces a second ranking of orderings, R2. In one embodiment, the ranking module 316 calculates another set of k weight matrices Z, such that Zᵢⱼ^{k}=Σᵢ^{k}[log(DPᵢⱼ^{k})−log(DPⱼᵢ^{k})], where DP is the embedded distance matrix of the set d={DP₂, DP₃, . . . DPₖ} in each dimension d={2, 3, . . . k}. In one embodiment, distance matrix DPₙ is formed such that the upper-diagonal is the upper-diagonal of P and the lower-diagonal is the transpose of the upper-diagonal of P. The ranking module 316, in another embodiment, performs a discrete Helmholtz-Hodge decomposition of each weight matrix Z. The output of the discrete Helmholtz-Hodge decomposition comprises 1 to k−1 orderings/rankings. In certain embodiments, the orderings comprise a plurality of column vectors (1 . . . k−1 vectors), where each column vector comprises orderings or rearranged indices. In a further embodiment, the ranking module 316 calculates the average of all the orderings produced by using symmetric matrices A and B to generate R2, which is a ranking of the calculated averages of all the ordering vectors.

The ranking module 316, in one embodiment, computes a discrete Helmholtz-Hodge rank on the total (2k+4) rankings from R1 and R2. The ranking module 316, in another embodiment, includes the top t points from the average k+1 ranking scores in the next sub-sample as well as bootstrap sample, which is sent to the estimation component 208 and the sampling component 210 to be processed in a new iteration.

The prediction apparatus 104, in another embodiment, includes a probability-ordering module 318 configured to order the event-prediction probabilities based on the one or more calculated event-prediction rankings. In this manner, the prediction apparatus 104 is able to rank prediction data that includes one or more inconsistencies by adjusting for the inconsistencies through an iterative process. In certain embodiments where the raw spatio-temporal data comprises crime data, the prediction apparatus 104 is able to rank different crime areas based on a predictive probability of a near repeat. The raw spatio-temporal data may have one or more ordering inconsistencies (e.g., it may be difficult to rank one location/time over another location/time), which are accounted for by the correction component 206 such that the raw spatio-temporal data may be assigned a ranking along with a predictive probability of a near repeat.

Thus, estimation module 304, the sampling module 306, and the correction module 312 iteratively process the received, raw spatio-temporal input data to efficiently generate prediction probabilities. Moreover, inconsistencies present in the prediction probabilities have been corrected through the iterative processing of the prediction probabilities in order to generate accurate spatio-temporal data predictions such as crime-related predictions.

In one embodiment, the prediction apparatus 104 includes a map module 320 configured to display a map of an area related to raw crime data. In one embodiment, the raw crime data includes a crime type, a crime location, such as latitude and longitude, and a crime timestamp. The raw crime data is processed by the prediction system 204, which produces one or more crime-prediction probabilities. The map displayed by the map module 320 is based on selected raw crime data. For example, a law enforcement officer may select a specific crime, e.g., arson, within a selected area, e.g., five mile radius, and within a specified time period. The map module 320, in certain embodiments, displays all instances of the selected crime on the map according to the preferences set by the user (e.g., the location and time).

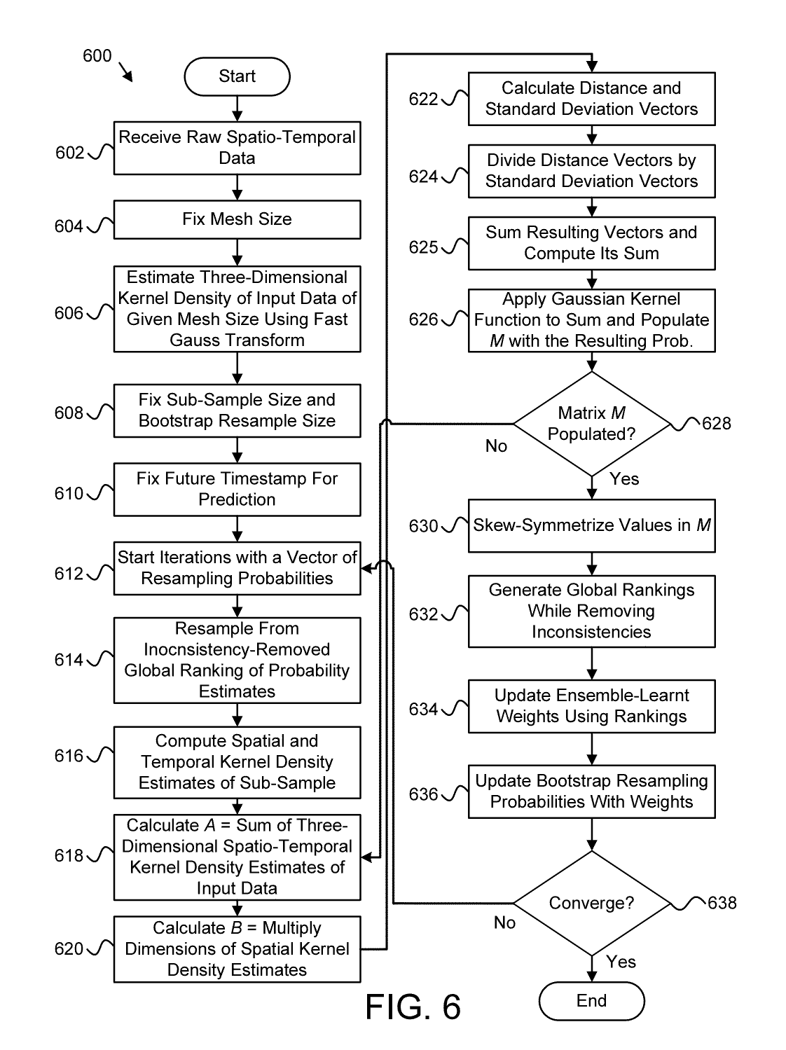

In another embodiment, the ordering apparatus 104 includes an overlay module 322 configured to display one or more hotspots over the mapped area displayed by the map module 320. The one or more hotspots, as shown below with reference to FIG. 6, highlight areas of the map where there is a high-probability of a near-repeat crime occurring. The different hotspot areas, in another embodiment, are ranked according to a priority, such that law enforcement personnel can more accurately make decisions regarding where to focus their activities. The hotspots, in another embodiment, are based on the crime-prediction probabilities, which have had any inconsistencies removed by the correction component 206, generated by the prediction system 204.

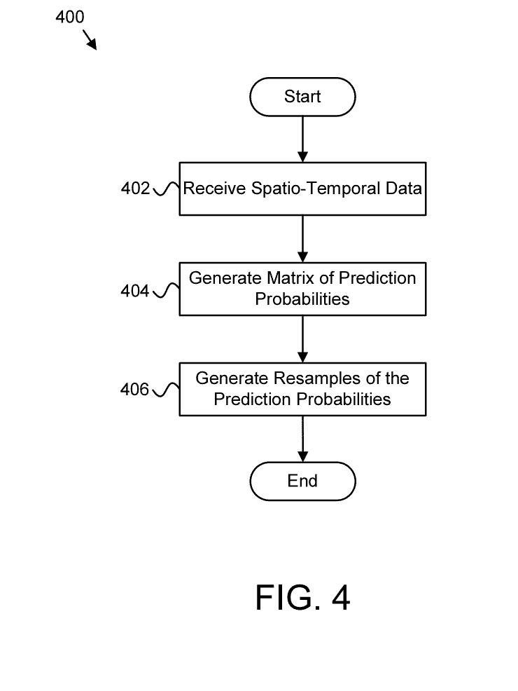

FIG. 4 depicts one embodiment of a method 400 for improving accuracy in a spatio-temporal prediction system. In one embodiment, the method 400 begins and a data module 302 receives 402 spatio-temporal data. In some embodiments, the spatio-temporal data comprises a timestamp and a location. In another embodiment, the spatio-temporal data includes crime data comprising a crime type, a timestamp, and/or a location (e.g., an address, latitude/longitude pair, or the like).

In another embodiment, an estimation module 304 generates 404 a real matrix of prediction probabilities. In certain embodiments, the estimation module 304 performs one or more kernel density estimations based on a point-processing model in order to calculate the real matrix of prediction probabilities. In a further embodiment, a sampling module 306 generates 406 resamples of the prediction probabilities, which are iteratively processed by the prediction system 204. In certain embodiments, this provides efficiency improvements when processing computationally-intensive operations (e.g., high-dimension kernel density estimations) because a smaller data set, which is representative of the entire data set, is processed. And the method 400 ends.

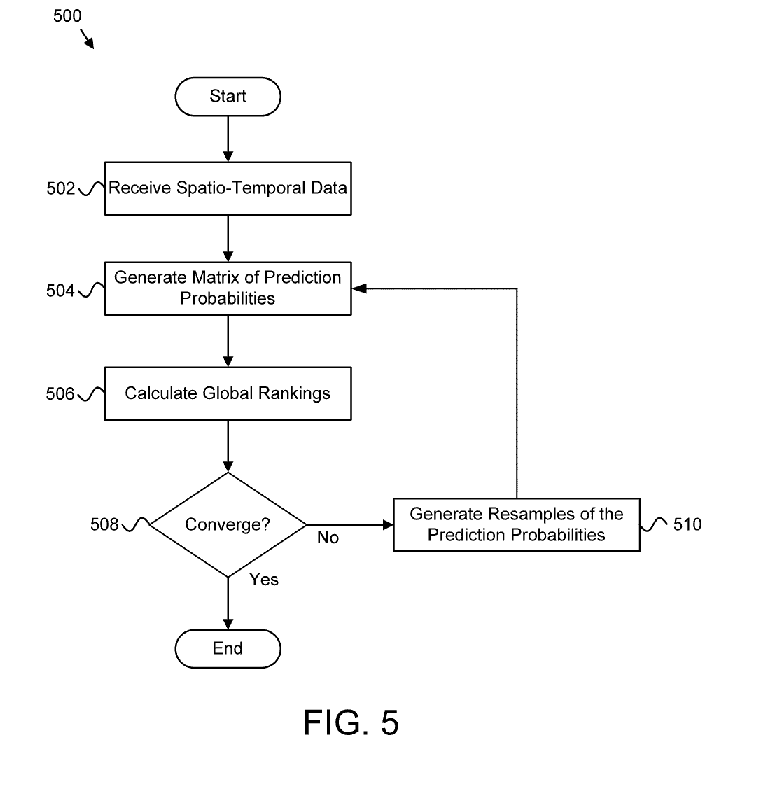

FIG. 5 depicts another embodiment of a method 500 for improving accuracy in a spatio-temporal prediction system. In one embodiment, the method 500 begins and a data module 302 receives 502 spatio-temporal data. In another embodiment, an estimation module 304 generates 504 a real matrix of prediction probabilities. In one embodiment, a correction module 312 calculates 506 one or more global rankings associated with the prediction probabilities while correcting inconsistencies present in the prediction probabilities. The sampling module 306, in another embodiment, determines 508 whether the process has converged on a predetermined value/threshold. If the process has not converged on a predetermined threshold, the sampling module 306 generates 510 resamples of the prediction probabilities based on the matrix of prediction probabilities and the global rankings, and the estimation module 304 generates 504 a new real matrix of prediction probabilities based on the resamples generated by the sampling module 306. This iterative process, in certain embodiments, is performed until the process converges 508 on a predetermined threshold and the method 500 ends.

FIG. 6 depicts another embodiment of a method 600 for improving accuracy in a spatio-temporal prediction system. In one embodiment, the method 600 begins and a data module 302 receives 602 raw spatio-temporal data, such as crime data describing a crime type, location, and timestamp. In a further embodiment, an estimation module 304 fixes 604 a mesh size, and estimates 606 a three-dimensional kernel density of the spatio-temporal data. In certain embodiments, the estimation module 304 computes a fast Gaussian transform to estimate 606 a three-dimensional kernel density of the spatio-temporal data.

In one embodiment, the estimation module 304 fixes 608 a sub-sample size and a bootstrap resample size. The estimation module 304, in another embodiment, fixes 610 a future timestamp for prediction, and starts 612 an iteration with a vector of resampling probabilities. In certain embodiments, at each iteration, a resample 614 is performed using inconsistency-removed global rankings of probability estimates. The estimation module 304, in one embodiment, computes 616 spatial and temporal kernel density estimates of the sub-sample, and calculates 618 a sum A of three-dimensional spatio-temporal kernel density estimates of the spatio-temporal input data, which is translated along the time dimension by the future timestamp. In another embodiment, the estimation module 304 calculates a multiple B of the dimensions of the spatial kernel indexes by a given spatial location of interest for prediction.

In one embodiment, the estimation module 304 calculates 622 distance vectors, D, and standard deviation vectors, SD, in order to determine prediction probabilities. For example, the estimation module 304 may calculate three vectors (arrays) of distances, D, and three vectors (arrays) from standard deviations and nearest neighbors, SD, for each record/row of the sub-sample. In such an embodiment, the estimation module 304 may calculate 622 three vectors of distances, D, for each component or dimension of input data e.g., {spatial dimension 1, spatial dimension 2, spatial dimension 3}, by subtracting the scalar in the corresponding dimension (column) and record (row) of the sub-sampled data and squaring the difference. The estimation module 304 may calculate 622 three vectors from standard deviations and nearest neighbors, SD, for each record (row) of sub-sampled data by computing the distances to K nearest neighbors in each dimension and multiplying or weighing the distances with the standard deviation of that component in the input data.

In one embodiment, the estimation module 304 divides 624 the distance vectors, D, by the corresponding standard deviation/nearest neighbors vectors, SD, on an element-by-element basis to generate another set of vectors, V. The estimation module 304 may sum 625 the vectors, V, on an element-by-element basis to generate a vector, W, and compute its sum, S. In some embodiments, the estimation module 304 applies 626 a Gaussian kernel function to S in order to generate a prediction probability for the data. As used herein, the Gaussian kernel function is an exponential decay function that includes a bandwidth parameter.

In one embodiment, the estimation module 304 iteratively calculates 622 distance vectors, D, and standard deviation/nearest neighbors vectors, SD, divides 624 the distance vectors, D, by the corresponding standard deviation/nearest neighbors vectors, SD, to generate resulting vectors, V, sums 625 V to generate a vector, W, and compute its sum, S, and applies 626 a Gaussian kernel function to the sum, S, for all possible combinations of tuples of columns in the data set (e.g., 1-tuple columns, 2-tuple columns, 3-tuple columns, and so on based on the total number of columns in the input dataset) in order to generate prediction probabilities until the matrix M has been populated. In one embodiment, the estimation module 304 populates matrix M with prediction probabilities calculated in 622-626. In certain embodiments, the correction module 312 skew-symmetrizes 630 the values in matrix M, in response to determining 628 that matrix M has is populated, and generates 632 one or more global rankings from the skew-symmetric matrix while removing intransitivities and cyclical inconsistencies in the data.

A sampling module 306, in one embodiment, updates 634 ensemble-learnt weights using the global rankings, and updates 636 bootstrap resampling probabilities using the ensemble-learnt weights. In one embodiment, the sampling module 306 determines if the process converged 638 to a threshold value (e.g., iteration limit, accuracy threshold, or the like). If the method has not converged 638, in one embodiment, the estimation module 304 starts 612 a new iteration with the updated resampling probabilities. Otherwise, the method 600 ends.

FIG. 7 depicts one embodiment of a crime-prediction map 700 in accordance with the present subject matter. In one embodiment, the map module 320 presents a mapped area 710, and an overlay module 322 presents a crime-prediction overlay over the mapped area 710. The map module 320 configures the mapped area 710, in one embodiment, based on the crime-data the user wants to view on the map. In another embodiment, the user selects a specific area to view crime data. For example, a user may specify viewing all larceny-related crimes, within ten miles, that occurred last week.

The overlay presented by the overlay module 322, in certain embodiments, presents one or more crime hotspots 702-708 on the mapped area 710, which describe areas with a high probability of near-repeat crimes, e.g., crimes that are likely to be repeated based on similar crime data. The crime hotspots 702-708, in certain embodiments, include an assigned priority based on the event-prediction data calculated by the prediction system 204 such that law enforcement personnel may be able to target their activities in areas where there is a higher-chance of near-repeat crimes occurring. In certain embodiments, the priority of the crime hotspots 702-708 may be visible on the map 700, e.g., different priority levels may be indicated using different colors, different line types/weights, different shapes, or the like. For example, higher-priority crime hotspots 702-708 may be shaded red, lower priority crime hotspots 702-708 may be shaded blue, and the lowest priority crime hotspots 702-708 may be shaded green. Alternatively, the crime hotspots 702-708 may be assigned a numerical priority, such as a ‘1’ for a high-priority crime hotspot 702-708, a ‘2’ for a lower priority crime hotspot 702-708, and a ‘3’ for the lowest priority crime hotspot 702-708. In certain embodiments, the visual priority indicators are derived from the rankings generated by the correction component 206. In some embodiments, a user may interact with a hotspot 702-708, e.g., by hovering over a hotspot 702-708 or touching a hotspot 702-708 on a touch-enabled device, to view additional information about the area of the map 700 associated with the hotspot 702-708, such as neighborhood information, crime statistics, demographics, or the like.

As described above, the event-prediction data that acts as the basis of the hotspots 702-708 is generated by a prediction system 204 processing raw crime data, such as a crime type, location, timestamp, and/or the like. This data may be manually entered by law enforcement personnel. Trying to rank this data, e.g., from best to worst, may be too subjective, which may create one or more ordering inconsistencies in the data. Thus, the correction component 206 of the prediction system 204, in certain embodiments as described above, together with the estimation component 208 and the sampling component 210, iteratively corrects for these inconsistencies such that more accurate rankings of crime data may be available.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a data module configured to receive spatio-temporal data, the spatio-temporal data comprising one or more of a time and a location;
an estimation module configured to generate one or more prediction probabilities for the spatio-temporal data; and
a sampling module configured to generate one or more resamples of the prediction probabilities.

2. The apparatus of claim 1, wherein the one or more prediction probabilities are calculated based on estimated values derived from the spatio-temporal data.

3. The apparatus of claim 2, wherein the estimation module further provides the spatio-temporal data to a point-processing model to generate the estimated values, the point-processing model being based on a Hawkes point-processing model.

4. The apparatus of claim 3, wherein the estimation module further divides the time value of the spatio-temporal data into a plurality of time variables representing a subset of the time value, the plurality of time variables being used as input into the point-processing model.

5. The apparatus of claim 3, wherein the estimation module further estimates a three-dimensional kernel density of a predetermined mesh size for the spatio-temporal data as part of the point-processing model, the estimated three-dimensional kernel density being calculated using a Gaussian transformation of the spatio-temporal data.

6. The apparatus of claim 2, wherein the estimation module further down-samples the spatio-temporal data by selecting a subset of the spatio-temporal data.

7. The apparatus of claim 1, wherein the estimation module generates the prediction probabilities according to a predetermined schedule.

8. The apparatus of claim 1, wherein the sampling module performs an ensemble learning method to generate one or more resamples of the prediction probabilities.

9. The apparatus of claim 1, further comprising a correction module configured to generate one or more rankings associated with the one or more prediction probabilities while correcting one or more inconsistencies of the one or more prediction probabilities.

10. The apparatus of claim 10, wherein the sampling module generates one or more resamples of the prediction probabilities according to the one or more rankings associated with the one or more prediction probabilities.

11. The apparatus of claim 1, wherein the spatio-temporal data comprises crime-related data, the crime-related data comprising a location of a crime and a date of a crime, wherein the prediction probabilities describe the likelihood of a future crime occurring.

12. The apparatus of claim 1, further comprising a map module configured to display an area of a map associated with the spatio-temporal data, the spatio-temporal data comprising crime-related data.

13. The apparatus of claim 12, further comprising an overlay module configured to overlay one or more hotspots on a map, the one or more hotspots indicating an area on the map that has a prediction probability above a predetermined threshold.

14. The apparatus of claim 13, wherein the one or more hotspots are associated with one or more selected crimes, the one or more hotspots representing a likelihood of a near-repeat of a selected crime occurring in an area of the map associated with the hotspot.

15. A method comprising:
receiving spatio-temporal data, the spatio-temporal data comprising one or more of a time and a location;
generating one or more prediction probabilities for the spatio-temporal data; and
generating one or more resamples of the prediction probabilities.

16. The method of claim 15, further comprising generating one or more rankings associated with the one or more prediction probabilities while correcting one or more inconsistencies of the one or more prediction probabilities.

17. The method of claim 16, wherein the one or more resamples of the prediction probabilities are generated according to the one or more rankings associated with the one or more prediction probabilities.

18. The method of claim 15, further comprising displaying an area of a map associated with the spatio-temporal data, the spatio-temporal data comprising crime-related data, the crime-related data comprising a location of a crime and a date of a crime, wherein the prediction probabilities describe the likelihood of a future crime occurring.

19. The method of claim 18, further comprising overlaying one or more hotspots on a map, the one or more hotspots indicating an area on the map that has a prediction probability above a predetermined threshold, wherein the one or more hotspots are associated with one or more selected crimes, the one or more hotspots representing a likelihood of a near-repeat of a selected crime occurring in an area of the map associated with the hotspot.

20. A program product comprising a computer readable storage medium that stores code executable by a processor, the executable code comprising code to perform:
receiving spatio-temporal data, the spatio-temporal data comprising one or more of a time and a location;
generating one or more prediction probabilities for the spatio-temporal data, the one or more prediction probabilities are calculated based on estimated values derived from the spatio-temporal data; and
generating one or more resamples of the prediction probabilities according to one or more rankings associated with the one or more prediction probabilities.
